(19) United States
(12) Patent Application Publication
(10) Pub. No.: US 2003/0043283 A1
(43) Pub. Date: Mar. 6, 2003

(54) Snapshot system

(76) Inventor: Yoshinobu Yamamoto, Tokyo (JP)

Correspondence Address: Gerald Levy, Esq., PITNEY, HARDIN, KIPP & SZUCH LLP, 685 Third Avenue, New York, NY, 10017-4024, US

(21) Appl. No.: 10/231,916

(22) Filed: Aug. 30, 2002

(30) Foreign Application Priority Data
Aug. 31, 2001 (JP) 2001-264630

(51) Int. Cl. H04N 5/76

(52) U.S. Cl. 348/231.3

(57) ABSTRACT

A snapshot system includes a digital still camera body installed in a flower bed or the like and a shutter device carried by a user. When the user arrives at a site near the snap spot of the digital still camera body, the shutter device receives a search signal and its speaker gives an alarm, thereby enabling the user to recognize that the site is the snap spot. When the user depresses the shutter button of the shutter device, a digital still camera apparatus receives the shutter drive signal, and causes the digital still camera body to take a picture of the user and his or her family at a very moment for a good picture.

This application is based on Patent Application No. 2001-264630 filed Aug. 31, 2001 in Japan, the content of which is incorporated hereinto by reference.

### BACKGROUND OF THE INVENTION

1. Field of the Invention

The present invention relates to a snapshot system.

2. Description of the Related Art

As for a snapshot taken by a still camera, a person who takes a picture usually releases the shutter with the camera in hands, leaving the person outside the picture.

However, when taking snapshots of the family in an amusement establishment such as a theme park, for example, it is natural that the photographer himself or herself wishes to be in the snapshots. In such a case, it is necessary at present to require somebody to photograph them, which presents a problem of being bothersome.

### SUMMARY OF THE INVENTION

The present invention is implemented to solve the foregoing problem. It is therefore an object of the present invention to provide a snapshot system capable of photographing at a desired shutter timing without a photographer.

According to a first aspect of the present invention, there is provided a snapshot system including a portable shutter controller having first communication means, a digital still camera apparatus that has second communication means and is installed at a specified site, and a management apparatus for managing the digital still camera apparatus, the snapshot system carrying out radio transfer of a signal between the shutter controller and the digital still camera apparatus via the first and second communication means, wherein

the shutter controller comprises a shutter button, and first communication control means for enabling signal transmission between the shutter controller and the digital still camera apparatus via the first and second communication means when approaching a photographing spot of the digital still camera apparatus, for sending an ID signal to the digital still camera apparatus, and for transmitting a shutter drive signal to the digital still camera apparatus in response to depression of the shutter button; and

the digital still camera apparatus comprises second communication control means for enabling signal transmission between the digital still camera apparatus and the shutter controller via the first and second communication means when the shutter controller approaches the photographing spot, for receiving the ID signal transmitted from the shutter controller, and for receiving the shutter drive signal output from the shutter controller, photographing means for taking a picture by driving a shutter in response to the shutter drive signal received, first storing means for storing the photograph signal from the photographing means in conjunction with the ID signal received, and feeding means for supplying the management apparatus with the photograph signal from the first storing means and the ID signal in conjunction with the photograph signal; and

the management apparatus comprises second storing means for storing the photograph signal supplied from the feeding means and the ID signal in conjunction with the photograph signal, and reading means for reading the photograph signal from the second storing means with reference to the ID associated with the photograph signal.

According to a second aspect of the present invention, there is provided a snapshot system including a portable shutter controller having first communication means, a digital still camera apparatus that has second communication means and is installed at a specified site, and a management apparatus for managing the digital still camera apparatus, the snapshot system carrying out radio transfer of a signal between the shutter controller and the digital still camera apparatus via the first and second communication means, wherein

the shutter controller comprises first communication control means for enabling signal transmission between the shutter controller and the digital still camera apparatus via the first and second communication means when approaching a photographing spot of the digital still camera apparatus, and for sending an ID signal to the digital still camera apparatus; and

the digital still camera apparatus comprises a sensor for detecting that a prescribed condition about the photographing spot is satisfied, second communication control means for enabling signal transmission between the digital still camera apparatus and the shutter controller via the first and second communication means when the shutter controller approaches the photographing spot, and for receiving the ID signal transmitted from the shutter controller, photographing means for taking a picture by driving a shutter in response to the detection signal output from the sensor, first storing means for storing the photograph signal from the photographing means in conjunction with the ID signal received, and feeding means for supplying the management apparatus with the photograph signal from the first storing means and the ID signal in conjunction with the photograph signal; and

the management apparatus comprises second storing means for storing the photograph signal supplied from the feeding means and the ID signal in conjunction with the photograph signal, and reading means for reading the photograph signal from the second storing means with reference to the ID associated with the photograph signal.

Here, the digital still camera apparatus may have an exclusive photographing mode; the second communication means may output an exclusive photographing instruction signal in the exclusive photographing mode; the shutter controller may comprise priority buttons; and the first communication control means, receiving the exclusive photographing instruction signal from the digital still camera apparatus, may supply the ID signal to the digital still camera apparatus in response to a specified operation of the priority buttons.

The digital still camera apparatus may have a simultaneous photographing mode; the second communication means may output a simultaneous photographing mode signal in the simultaneous photographing mode; the first communication means, receiving the simultaneous photographing mode signal from the digital still camera apparatus, may output the shutter drive signal along with the ID signal; and the second communication means receives, in the simultaneous photographing mode, different ID signals from a plurality of shutter controllers approaching the photographing spot, then the second communication means receives a first shutter drive signal and the ID signal associated with the first shutter drive signal, and when the second communication means receives a second shutter drive signal within a fixed time period after receiving the first shutter drive signal and the ID signal associated with the first shutter drive signal, the first storing means may store the photograph signal based on the first shutter drive signal, the ID signal associated with the first shutter drive signal, and the ID signal associated with the second shutter drive signal.

The photographing means may drive the shutter a plurality of times in response to the ID signal received to photographs a plurality of times.

The management apparatus may further comprise printing means for printing a picture based on the photograph signal the reading means reads from the second storing means.

The management apparatus may further comprise feeding means for feeding via the Internet the photograph signal the reading means reads from the second storing means.

The management apparatus may further comprise means for charging a fee to a client who receives the photograph signal read from the second storing means and transmitted by the feeding means via the Internet.

The above and other objects, effects, features and advantages of the present invention will become more apparent from the following description of embodiments thereof taken in conjunction with the accompanying drawings.

### BRIEF DESCRIPTION OF THE DRAWINGS

FIG. 1 is an external view of a shutter device;

FIG. 2 is a block diagram showing a configuration of the shutter device;

FIG. 3 is a block diagram showing a configuration of a management apparatus and a digital still camera apparatus;

FIG. 4 is a view showing an example of the operation mode of the snapshot system;

FIG. 5 is a view showing another example of the operation mode of the snapshot system;

FIG. 6 is a view showing still another example of the operation mode of the snapshot system; and

FIG. 7 is a view showing another example of the operation mode of the snapshot system.

### DETAILED DESCRIPTION OF THE PREFERRED EMBODIMENT

The invention will now be described with reference to the accompanying drawings.

The following embodiment in accordance with the present invention applies the snapshot system to a theme park establishment.

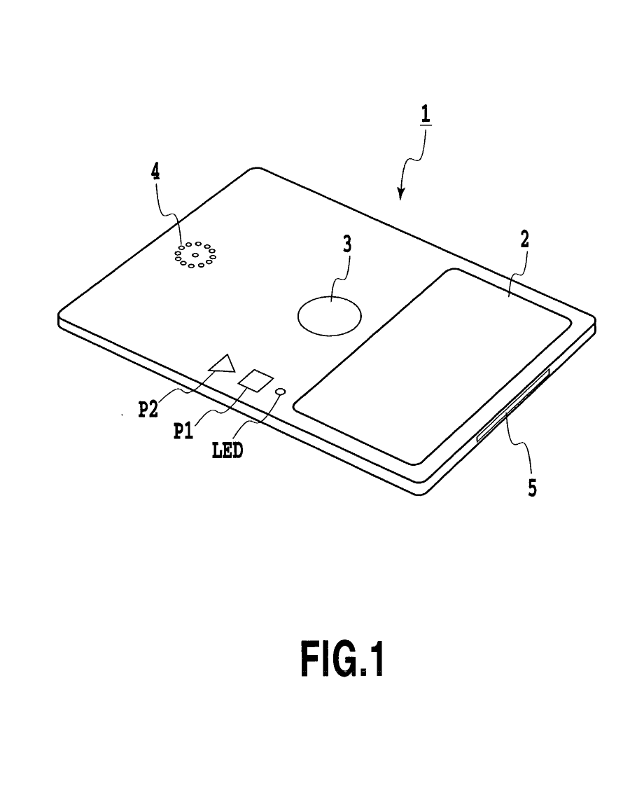

FIG. 1 shows an appearance of a small portable shutter device. The shutter device 1 is the size of an IC card, cash card or the like, for example. It comprises on its surface a display 2 consisting of a liquid-crystal display, an LED (light-emitting diode), a shutter button (release button) 3, two priority buttons P1 and P2, and a speaker 4. It further comprises on its side an antenna 5 constituting a part of a communication device, which will be described later.

The LED indicates that the shutter device 1 is in a photographable state.

The priority buttons P1 and P2 are square and triangular, respectively, to be easily distinguished. Although their details will be described later, they are used when a plurality of shutter devices are present in the same photographing spot (that is, when a plurality of families or groups are present each having a shutter device) and when the digital still camera apparatus for taking the photographing spot is set in an exclusive photographing mode, or is ready to take another photograph. The exclusive photographing mode is the mode that enables only one of the shutter devices in the photographing spot to release the shutter of the digital still camera apparatus, while it is allowed to release the shutter. For example, the user can recognize that the digital still camera apparatus for photographing the spot is set at the exclusive photographing mode by looking at a mark that indicates the mode and is visible from the user having the shutter device in the photographing spot. The mark can be formed, for example, on a stand which supports the digital still camera apparatus and is seen from the photographing spot, or on a monitor for monitoring the photograph signal of the digital still camera apparatus, in such a manner that two square marks and one triangular mark are placed in the order of the square, square and triangle, with arrows indicating that the square priority button is depressed twice consecutively, and then the triangular button is depressed once. On the monitor, the square, square and triangular marks are turned on cyclically to notify the user that the exclusive photographing mode is set, and that depressing the square priority button P1 on the shutter device twice and the triangular priority button P2 once causes the LED to illuminate, and enables only that shutter device to take pictures at the point (the details of which will be described later).

The shutter devices 1 are lent to visitors to the theme park establishment at their wish (the details will be described later).

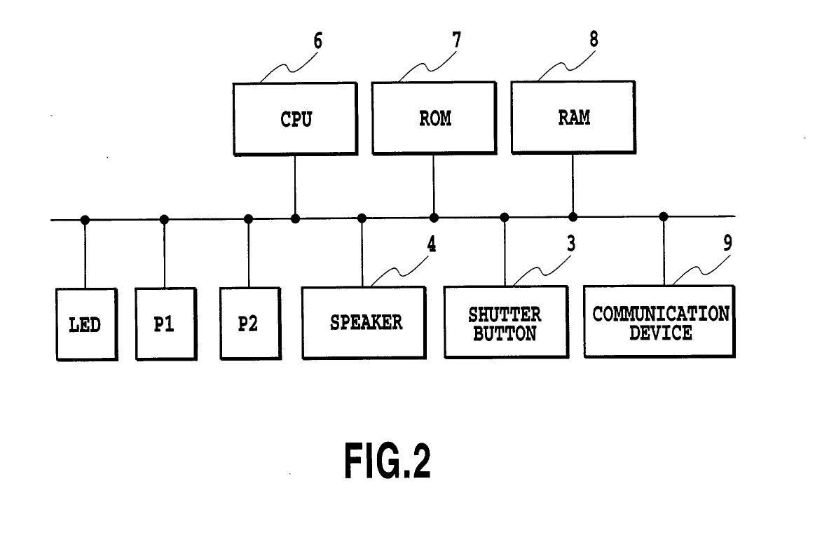

FIG. 2 is a block diagram showing a circuit configuration of the shutter device 1. In FIG. 2, the reference numeral 6 designates a CPU for controlling the shutter device 1 in its entirety; 7 designates a ROM for storing programs for operating the CPU 6; and 8 designates a RAM providing a working area of the CPU 6. The reference numeral 9 designates a communication device including the antenna 5 for transmission and reception. The components of the shutter device 1 are driven by a battery (not shown) of the shutter device 1.

The radio frequency band the communication device 9 uses is a UHF band, for example. The radio wave transmitted from the communication device 9 is very weak because it is enough to cover only several meters. Thus, the transmission power of a few milliwatts is enough as the power to be supplied to the antenna 5, for example. Although the details will be described later, the communication device 9, communicating with a communication device 15 of a digital still camera apparatus placed at a certain position within a range capable of exchanging the radio waves, provides the digital still camera apparatus with necessary information, and receives necessary information from the digital still camera apparatus.

The RAM 8 stores ID information (eight-digit number, for example) that is proper to the shutter device 1, and is read out as needed as will be described later.

The CPU 6 reads the ID information from the RAM 8 in response to a search signal received by the communication device 9. The search signal is continuously transmitted from the communication device 15 installed near the spot photographed by the digital still camera apparatus. Receiving the search signal, the communication device 9 transfers it to the speaker 4 to raise the alarm. On the other hand, the communication device 15 on the digital still camera apparatus receives the ID signal. Thus, the digital still camera apparatus can recognize (manage) IDs of the shutter devices present at the photographing spot, and the users of the shutter devices within the photographing spot can recognize that the site is the photographing spot, though the details will be described later. As long as the communication device 9 receives the search signal continuously transmitted from the communication device 15 (that is, while the shutter device is present at the photographing spot), the CPU 6 of the shutter device reads the ID information from the RAM 8, and has the communication device 9 transmit it periodically. Consequently, while the communication device 15 receives the ID signal, the digital still camera apparatus can recognize (manage) the IDs of the shutter devices present within the photographing spot.

Furthermore, when the shutter button 3 is depresses while the shutter device satisfies prescribed conditions which will be described later, the CPU 6 supplies a shutter drive signal to the communication device 9 to transmit the shutter drive signal by radio. The number of times the shutter button 3 is depressed is shown on the display 2. Although the details will be described later, it is possible for the display 2 to display a monitor image signal of the digital still camera apparatus received by the communication device 9 as needed. Since a small time delay is present from the depression of the shutter button 3 to the actual drive of the shutter of the digital still camera body through the detection of the shutter drive signal by the digital still camera apparatus, it is possible to design such that a pseudo-shutter operation sound is produced from the speaker 4 when the shutter button 3 is being depressed for the time corresponding to the time delay. This enables the user to recognize the actual shutter operation point more accurately, and serves to prevent the user (group or family) from moving until the delay time has elapsed from the depression of the shutter button 3.

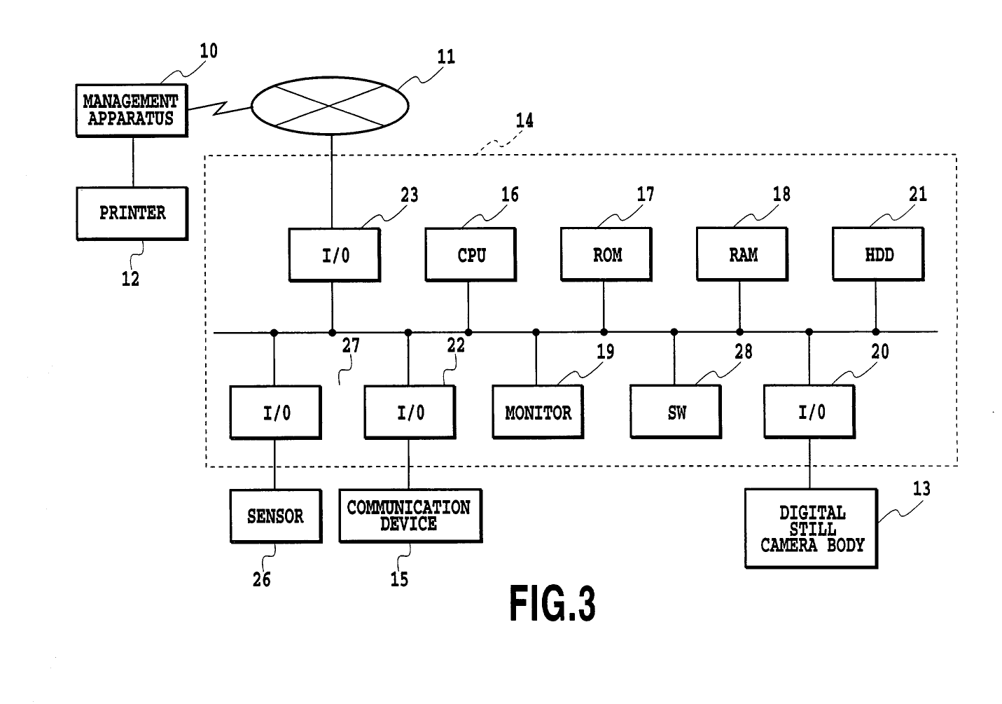

FIG. 3 is a block diagram showing a configuration of the digital still camera apparatus and management apparatus. The management apparatus 10, which is installed in a management facility in the theme park establishment, comprises a computer system and an interface connected to a network 11 as a communication means, for example. The interface transfers information between a plurality of digital still camera apparatuses and the computer system, which will be described later. The reference numeral 12 designates a printer controlled by the management apparatus 10. The printer prints a thumbnail picture corresponding to an image photographed for the ID of each shutter device. Although the details will be described later, the computer system in the management apparatus 10 is connected to a server system on the Internet. The server system carries out the following processes (1)-(4) as the need arises.

(1) It accesses the computer system in the management apparatus 10, and acquires the data in the computer system.

(2) It displays thumbnail image data on the Web site with a URL assigned to the server system, when a user input a password to a computer connected to the Internet, which thumbnail images are based on images photographed by the user. Further, when the user wants the data to be displayed, at least one of thumbnail image data based on an image photographed in an automatic photographing mode and thumbnail image data based on an automatically photographed images (details will be described later) of a plurality of shots before and after the timing at which the user takes a picture is displayed.

(3) It allows a user to download required high-resolution image data, when the user who accesses the Web site clicks desired thumbnail images of the displayed images to download the original image data of the thumbnail images (that is, high-resolution image data photographed by the digital still camera body).

(4) It charges a fee according to the ID number of a credit card registered by the user in accordance with the number (amount) of the downloaded image data as will be described later.

The computer system in the management apparatus 10 can also serve as the server system. In addition, instead of using the network 11, it is also possible to use as the communication means a radio connection between the interface of management apparatus 10 and an I/O (interface) 23 of a control device 14 of each of the plurality of digital still camera apparatuses.

Although the details will be described later, the digital still camera apparatus comprises a digital still camera body 13 installed at a predetermined site in the theme park establishment, the control device 14 for controlling the digital still camera body 13 in order to photograph digital still images, and a communication device 15. The control device 14 also controls the communication device 15 installed near the photographing spot of the digital still camera body 13. The control device 14 also inputs signals from sensors 26 via an I/O 27. The sensors, which are mounted at predetermined places as needed, include sensors such as infrared sensors for detecting persons and vehicles (such as a water chute), sensors for detecting start of an event that begins at certain timing such as intermittent spring and the like.

The control device 14 has the following configuration. The reference numeral 16 designates a CPU for controlling the digital still camera body 13, the control device 14 and the communication device 15 in their entirety. The reference numeral 17 designates a ROM for storing programs for operating the CPU 16, and 18 designates a RAM for providing the CPU 16 with a working area. The reference numeral 19 designates a monitor for displaying a monitor image signal supplied from the digital still camera body 13. The monitor 19 is mounted at a site easily visible from the photographing spot of the digital still camera body 13 such as a location near the digital still camera body 13.

The communication device 15 includes a transmitting and receiving antenna. The frequency band of the signals transmitted and received by the antenna is a UHF band, for example. Since it is enough for the transmitted radio wave to cover a range of about a few meters, the transmission power fed to the antenna of the communication device 15 is very low on the order of a few milliwatts. The communication device 15 transmits the search signal continuously. When the user having the shutter device 1 arrives at the photographing spot near the communication device 15, the communication device 15 of the shutter device 1 receives the search signal from the communication device 15, and sends the ID signal as a reply. When the communication device 15 receives the reply, the CPU 16 temporarily stores the ID in the RAM 18. As long as the communication device 15 receives the ID periodically, the communication is established between it and the shutter device with the ID. Accordingly, the CPU 16 recognizes that the shutter device with the ID is present within the photographing spot, and correlates the ID with the photograph signal generated during the interval. When the communication device 15 stops receiving the ID, the CPU 16 cancels the communication with the shutter device of the ID. As a result, the ID temporarily stored in the RAM 18 is deleted.

The control device 14 has a normal photographing mode, exclusive photographing mode, simultaneous photographing mode and automatic photographing mode, and the CPU 16 can select and set one of them with a manual switch 28. These modes operate as follows.

Normal Photographing Mode

The normal photographing mode is a common photographing mode. When the user having the shutter device 1 arrives at photographing spot near the site at which the communication device 15 of the digital still camera apparatus is installed, the communication device 9 of the shutter device 1 receives the search signal from the communication device 15, and the speaker 4 gives the alarm as described above, thereby informing the user that it is the photographing spot. Thus the shutter device 1 turns on the LED, and sends back the ID signal. When the communication device 15 receives the ID signal, the CPU 16 temporarily stores the ID in the RAM 18. Accordingly, as long as the communication device 15 periodically receives the ID from the communication device 9 of the shutter device 1, the CPU 16 maintains the communication with the shutter device of the ID. On the other hand, the LED on the shutter device 1 that stays illuminated indicates that the user can take pictures at the photographing spot. Thus, depressing the shutter button 3 at an appropriate timing, the user can send the shutter drive signal from the communication device 9. In this case, the CPU 6 of the shutter device 1 turns off the LED once in response to the depression of the shutter button 3. Then, it turns on the LED again after a fixed time period in response to the search signal as long as it is received from the communication device 15. The fixed time period, which corresponds to the so-called recovery time that enables the digital still camera body 13 to take a next picture after the shutter release, is typically a few seconds.

Receiving the shutter drive signal from the communication device 9 via the communication device 15, the CPU 16 of the control device 14 supplies the shutter drive signal to the digital still camera body 13 via the I/O 20 in response to the received signal, thereby causing the still camera body 13 to photograph. Specifically, the digital still camera body 13 drives the shutter in response to the shutter drive signal, and shoots a subject at the photographing spot, thereby outputting the photograph signal. The CPU 16 temporarily stores in the RAM 18 the photograph signal supplied from the digital still camera body 13 via the I/O 20. Then the CPU 16 stores the photograph signal in a hard disk drive 21, which serves as a large capacity storing medium, in conjunction with the ID signal that is received by the communication device 15 and temporarily stored in the RAM 18. The I/O 23 in the control device 14 supplies the photograph signal together with the ID signal stored in the hard disk drive 21 to the management apparatus 10 via the network 11. Receiving the photograph signal in conjunction with the ID signal, the management apparatus 10 stores them on its hard disk drive serving as a large capacity storing medium. The hard disk drive 21 in the control device 14 is not essential. When it is not used, the CPU 16 temporarily stores in the RAM 18 the photograph signal supplied from the digital still camera body 13 via the I/O 20 in conjunction with the ID signal. Then, every time a fixed amount of data is stored in the RAM 18, the CPU 16 reads the data from the RAM 18, and supplies it to the management apparatus 10 via the I/O 23 and network 11.

In the normal photographing mode, the CPU 16 can read the photograph signal of the user from the RAM 18, and display it on the monitor 19 for a fixed time period of about 20 seconds, for example (when the shutter button is depressed to take the next picture, the image is deleted even before the fixed time period has elapsed). Consequently, the user (group, family or the like) at the photographing spot can confirm the current picture displayed on the monitor 19. If the user wishes to take a picture again, he or she can take it in the following procedure. The CPU 6 of the shutter device 1 sends a cancel signal via the communication device 9 when the user depresses the priority button P1 or P2 twice consecutively. Receiving the signal via the communication device 15, the CPU 16 deletes the current image data from the RAM 18 with reference to the ID stored in conjunction with the image data. Thus, the CPU 16 establishes for that ID a shutter drive signal waiting state for the next photograph. When the shutter button 3 of the shutter device 1 is depressed, and the shutter drive signal is supplied in this state, the CPU 16 stores it in the RAM 18 in the same manner as described above. To display on the display 2 of the shutter device 1 the photograph signal which is sent from the digital still camera apparatus to the shutter device 1 via the communication devices 15 and 9, the CPU 16 also reads the photograph signal taken by the user from the RAM 18, and transmits it for a fixed time period (about 20 seconds, for example) via the communication device 15. Receiving the photograph signal sent from the communication device 15 by the communication device 9, the shutter device 1 displays it on the display 2.

Exclusive Photographing Mode

The exclusive photographing mode is the mode that enables the depression of the shutter button of only one of the shutter devices in the photographing spot of the digital still camera body 13, while the digital still camera body 13 is allowed to release the shutter. In this mode, the control device 14 continuously sends an exclusive photographing instruction signal from the communication device 15 in addition to the search signal or in superimposition on the search signal. As described above, when the user of the shutter device 1 arrives at the photographing spot of the digital still camera apparatus in the exclusive photographing mode, the communication device 9 of the shutter device 1 of the user receives the search signal from the communication device 15, and the speaker 4 raises an alarm, thereby notifying the user that it is the photographing spot. In response to the exclusive photographing instruction signal received, the CPU 6 in the shutter device 1 reads the ID from the RAM 8 in response to the depression of the priority buttons P1 and P2 in a prescribed procedure as will be described later, and sends the ID signal via the communication device 9. At the same time, the CPU 6 turns on the LED for a predetermined time period (30 seconds, for example) to notify the user that the user can take a picture by depressing the shutter button 3 as long as the LED stays illuminated, because the shutter drive signal is transmitted from the communication device 9 by depressing the shutter button 3. When the shutter button 3 is depressed once, the CPU 6 turns off the LED, and annuls the subsequent depression of the shutter button 3. Specifically, the CPU 6 resets the exclusive photographing enabled state established by the prescribed depression procedure of the priority buttons, and inhibits the transmission of the shutter drive signal even if the shutter button 3 is depressed. However, by carrying out the prescribed depression procedure of the priority buttons after the recovery operation time of digital still camera body 13 has elapsed from the turn off of the LED, the exclusive photographing enabled state can be established again. In this case, looking at the marks visible only to the user in the photographing spot who has the shutter device, that is, the two square marks and one triangular mark, the user depresses the square priority button P1 on the shutter device 1 twice, and then the triangular priority button P2 once. Consequently, the LED is turned on for 30 seconds, for example. Thus, the user can recognize that the shutter button is effective as long as the LED stays illuminated. Incidentally, it is possible to cancel an erroneous operation of the priority buttons by depressing one of the priority buttons four times consecutively, for example. On the other hand, the CPU 16 in the control device 14 of the digital still camera apparatus receives the ID signal, which is transmitted from the communication device 9, via the communication device 15, and temporarily stores it in the temporarily storing area in the RAM 18, which is prepared for the exclusive photographing mode. Then, the CPU 16 waits for the shutter drive signal to be supplied from the communication device 15 for the predetermined time (30 seconds in the example). When the shutter drive signal is supplied during the time period, the CPU 16 supplies the shutter drive signal to the digital still camera body 13 via the I/O 20 so that the digital still camera body 13 takes a picture. In this case, the other users in the same photographing spot may depress their shutter buttons erroneously. However, since they do not carry out the procedure to enable the exclusive photographing mode (that is, the depressing procedure of the priority buttons in the specified sequence), the shutter drive signal is never transmitted. The subsequent operation of the digital camera apparatus is the same as that of the normal photographing mode, except that the ID associated with the photograph signal is the ID that is temporarily stored in the temporarily storing area prepared for the exclusive photographing mode in the RAM 18.

Simultaneous Photographing Mode

The simultaneous photographing mode is a mode that enables at least two users of the shutter devices to depress the shutter buttons simultaneously in the photographing spot of digital still camera body 13 while the release of the shutter of the digital still camera body 13 is allowed. As an example, the two users of the two shutter devices are referred to as user A and user B. In the simultaneous photographing mode, the communication device 15 continuously transmits the simultaneous photographing mode signal in addition to the search signal or in superimposition on the search signal. Receiving the simultaneous photographing mode signal, the CPU 6 of the shutter device 1 controls the communication device 9 in such a manner that the communication device 9 transmits the ID in the RAM 8 in conjunction with the shutter drive signal. However, the user does not recognize that the photographing spot is in the simultaneous photographing mode. When the user A or B arrives at the photographing spot of the digital still camera apparatus in the simultaneous photographing mode, the communication device 9 of his or her shutter device 1 receives the search signal and simultaneous photographing mode signal from the communication device 15, and the speaker 4 raises the alarm as described above. Consequently, the user A or B can recognize that it is the photographing spot. Then, receiving the search signal, the CPU 6 of the shutter device transmits the ID signal in response to the search signal, and causes the LED to stay illuminated until the following conditions are satisfied. Receiving the ID signal, the digital still camera apparatus temporarily stores the ID in the temporarily storing area in the RAM 18 used for the simultaneous photographing. In this case, a plurality of IDs are stored in the area.

Assume that the user A depresses the shutter button 3 on the shutter device. Then, the shutter device of the user A transmits the shutter drive signal and the ID signal. Receiving them, the digital still camera apparatus causes the digital still camera body 13 to take a picture. Then, it temporarily stores the photograph signal in the RAM 18 in conjunction with the ID of the user A. At the same time, although the LED on the shutter device of the user A is turned off, the LED on the shutter device of the user B remains on. If the user B depresses the shutter button 3 of the shutter device within a few seconds from the time the user A depresses the shutter button on the shutter device, the LED on the shutter device of the user B is turned off, and the shutter drive signal is transmitted from the shutter device. Incidentally, the few seconds mentioned above is a time period from the time when the digital still camera body 13 takes a picture in response to the shutter drive signal generated by the depression of the shutter button 3 on the shutter device by the user A to the time the next photographing is enabled. The time period, which is variable depending on the performance of the digital still camera body, can be within one second. In spite of the depression of the shutter button by the user B within the few seconds, the digital still camera apparatus does not take any picture even though the signal is received. Instead, it responds to the shutter drive signal from the user B, and temporarily stores the photograph signal of the user A in the RAM 18 in conjunction with the ID of the user B. Consequently, the picture taken by the user A is processed as a picture taken by the user B. The CPU 6 of the shutter device of each of the users A and B turns on the LED again after the fixed time (30 seconds, for example) has elapsed from the time the LED is turned off under the condition that the search signal is received. The foregoing description is applicable to three or more users. In this case, three or more IDs are stored in the RAM 18 in conjunction with one photograph signal.

When the user B does not depress the shutter button of the shutter device at the foregoing timing, the LED of the shutter device of the user B remains illuminated even after the foregoing timing as long as the user B is in the photographing spot, thereby enabling the next photographing. In this case, when the user B depresses the shutter button 3 of the shutter device, the shutter device of the user B transmits the shutter drive signal in conjunction with the ID signal, providing the next photograph signal associated with the ID of the user B.

Automatic Photographing Mode

The automatic photographing mode is the mode that causes the CPU 16 of the digital still camera apparatus to supply the shutter drive signal to the digital still camera body 13 in response to the detection output from the sensor 26. The sensor 26 is placed near a site in a haunted house at which a particular goblin jumps out, for example. The communication device 15 is installed near a passage reaching the site. Since the shutter device 1 of the user receives the search signal from the communication device 15 immediately before the user arrives at the site as a spectator, the control device 14 of the digital still camera apparatus can recognize the ID of the shutter device. The sensor 26 detects the user (group, family or the like) and outputs a detection signal. Thus, when the user arrives at the site as a spectator, the goblin jumps out and surprises the user so that a picture of the surprised user (group, family or the like) is taken and stored in conjunction with the ID. In this case, it is possible to use strobe light as needed when photographing. When a lot of people want to take pictures at a particular site, it is possible for the sensor 26 installed at the site to detect the user (group, family or the like) who arrives at the site, and for the CPU 16 to establish an arrangement such that the photograph is taken in a few seconds after that.

In each of the above-described photographing modes, the digital still camera apparatus can carry out sequential photographing as follows. That is, when the user having a shutter device 1 arrives at the photographing spot near the site at which the communication device 15 is installed and the communication device 15 receives an ID signal from the shutter device 1, during the time in which the communication device 15 receives the ID signal, the digital still camera body 13 carries out sequential photographing (Photography interval is based on the performance of the digital still camera 13. The photography interval is of once in a few seconds to a few to more than ten times per second.) and the sequential photography signals are temporarily stored in the RAM 18. Even if the shutter drive signal from the shutter device 1 is not received, such sequential photographing is carried out. However, in the case in which the shutter button 3 of the shutter device 1 is pressed, signals as follows are supplied from the control device 14 to the management apparatus 10. That is, the photograph signal produced by carrying out photographing in response to the reception of the shutter drive signal by the communication device 15 and photography signals of a few shots to tens of shots before and after the timing at which the picture is taken are associated with the ID signal temporarily stored in the RAM 18 to be supplied to the management apparatus 10. The management apparatus 10 stores the signal supplied from the control device 14 in a large capacity storage medium such as a hard disc drive. Advantage is produced by carrying out such sequential photographing especially in, e.g. the following case:

For example, a group photo satisfactory to everybody cannot be taken by merely pressing the shutter button 3 of the shutter device 1 at an appropriate timing since somebody may turn their face in a lateral direction or close their eyes.

However, provability of getting a photo in which everybody looks at the camera or another interesting photo is dramatically increased by checking some photos taken before and after the timing at which the picture is taken. Further, at the timing of about 10 seconds before taking, e.g. the commemorative picture, since nobody is camera conscious, a natural snap can be shot. It is possible to get an entertaining snap which cannot be got by photographing only once.

A set of the digital still camera body 13, control device 14 and communication device 15 with the foregoing configuration is located at each of several spots in the theme park establishment. Referring to examples of such locations, the operation of the snapshot system of the present embodiment will be described.

For example, the snapshot system of the present embodiment is explained in the name of snapshot service to the user who receives the service.

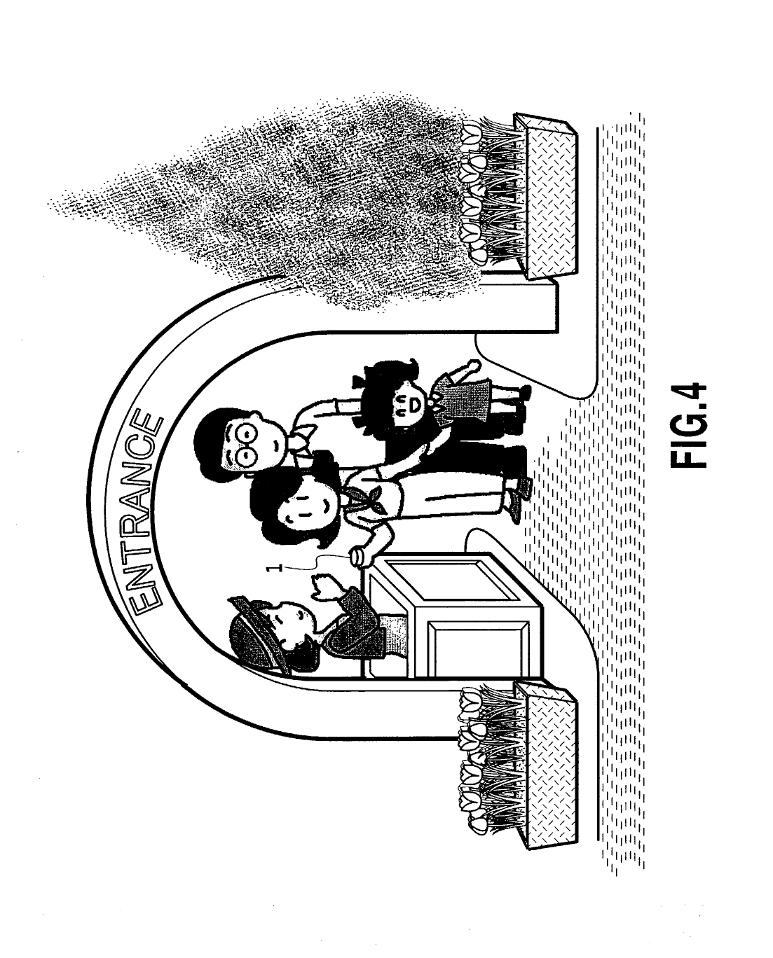

As shown in FIG. 4, the user receives (borrows) the shutter device 1 at an entrance to the theme park establishment. At the reception, the user writes the ID of his or her credit card as required on a form for borrowing the shutter device 1. A person in charge operates a terminal to record the information such as the ID of the credit card in the management apparatus 10 along with the ID of the shutter device 1.

The digital still camera body 13 of the digital still camera apparatus is installed at a site capable of photographing an appropriate snap spot in the theme park establishment. For example, it is set on a flower bed, in potted plants or in a barrel. The control device 14 is connected to the digital still camera body 13 via a cable. The antenna of the communication device 15 is set at a site capable of receiving the shutter drive signal and the ID signal sent from the shutter device 1 of the user at the snap spot. In this case, the digital still camera apparatus is placed at the normal photographing mode or exclusive photographing, mode.

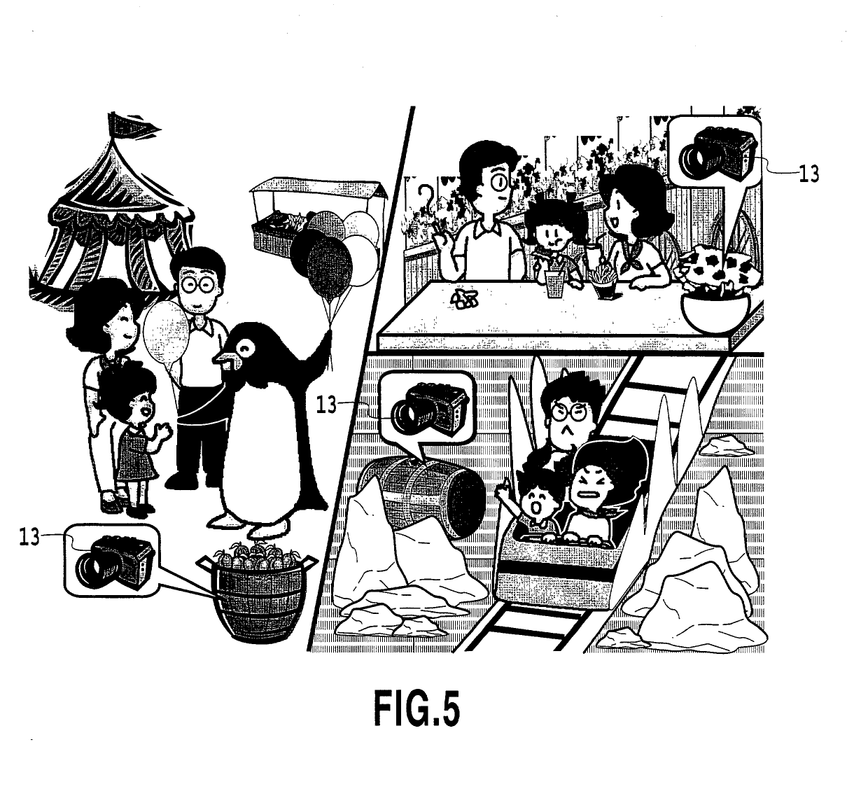

For example, when the snap spot is set on the way down to the ground of a water chute as shown in FIG. 5, the automatic photographing mode is used.

The photograph signals acquired by the individual digital still camera apparatuses and the ID signals associated with the signals are collected by the management apparatus 10 via the control device 14 and network 11, and are stored in the hard disk drive serving as a large capacity storing medium.

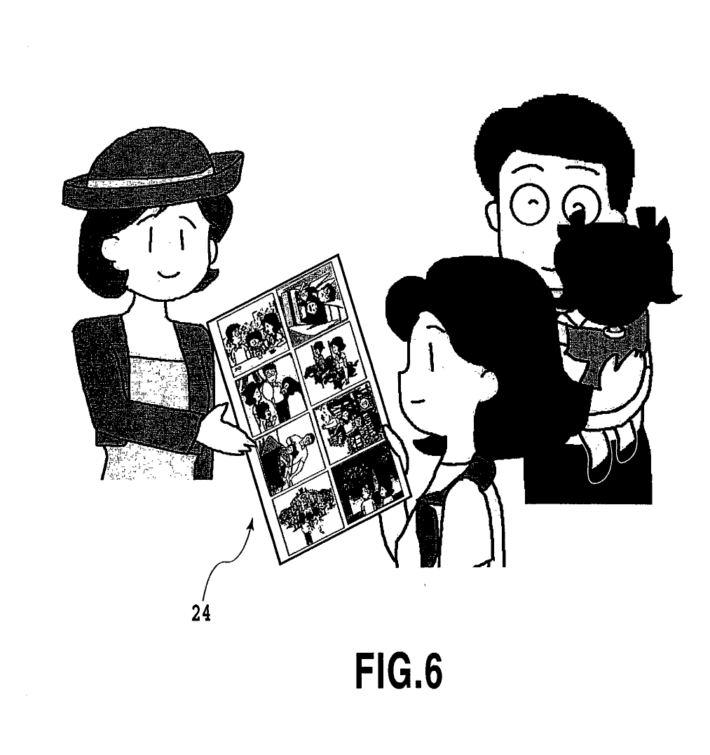

As shown in FIG. 6, the user returns the shutter device 1 at an exit of the theme park establishment. In this case, the user receives, in exchange of the shutter device 1, a sheet 24 on which pictures taken by the user and, if the user wants, thumbnails of the pictures unintentionally taken by the user are printed, and a sheet on which the URL and a password are recorded. The URL and password can also be transmitted to the user by mail. The thumbnails of the pictures taken by the user and photographed automatically are obtained as follows. First, a person in charge at the exit inputs the ID proper to the shutter device 1 returned by the user by operating the terminal such as a bar code reader connected to the management apparatus 10, which ID is printed on the surface of the device 1 in a bar code. Second, in response to the input ID, the management apparatus 10 reads the image data associated with the ID from the hard disk drive. Finally, the printer 12 prints out the thumbnail pictures of the image data. The charge of printing the thumbnail images may be free. When charged, the charge is paid immediately at the position. Otherwise, referring to the ID number of the credit card that is stored in the management apparatus 10 together with the ID of the shutter device when lending the shutter device, the charge can be imposed on the card.

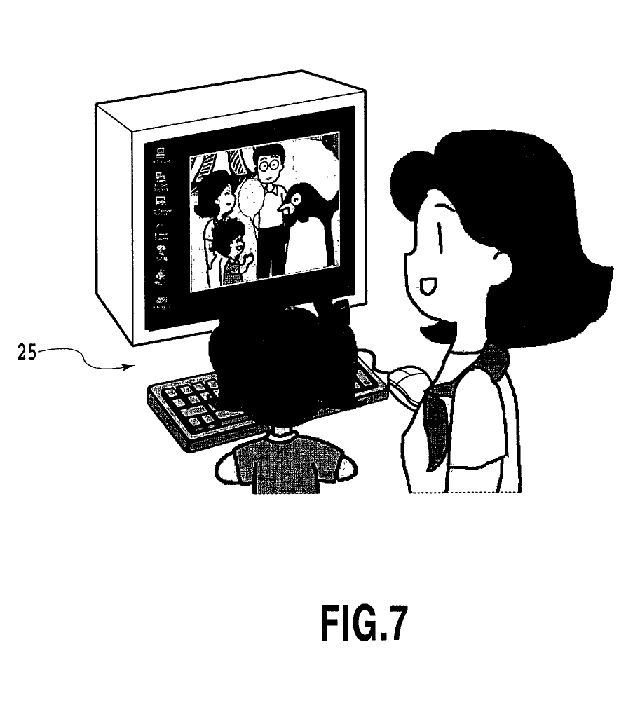

Next, as shown in FIG. 7, after returning home, the user operates a personal computer 25 accessible to the Internet to make an access to the URL on the Internet, which URL was handed along with the thumbnail image. Then, inputting the password given at the same time enables the user to look at the thumbnail pictures just like the thumbnail print corresponding to an image photographed by the user and, if the user wants, enables the user to look at thumbnails of the pictures unintentionally taken by the user. Accordingly, clicking desired thumbnail images makes it possible to download the original image data (high-resolution such as 300 million pixels providing a quality of photography). Using the downloaded data, the printer can print out high-definition pictures. According to the number of downloaded sheets, the snapshot system operator charges the fee to the user's credit card. As to a user who cannot access the Internet or a user who wishes for, it is possible for the snapshot system operator to deliver the high-definition pictures the user requires by mail at a fee.

The present invention has been described in detail with respect to preferred embodiments, and it will now be apparent from the foregoing to those skilled in the art that changes and modifications may be made without departing from the invention in its broader aspect, and it is the intention, therefore, in the apparent claims to cover all such changes and modifications as fall within the true spirit of the invention.

What is claimed is:

1. A snapshot system including a portable shutter controller having first communication means, a digital still camera apparatus that has second communication means and is installed at a specified site, and a management apparatus for managing the digital still camera apparatus, said snapshot system carrying out radio transfer of a signal between said shutter controller and said digital still camera apparatus via said first and second communication means, wherein
said shutter controller comprises a shutter button, and first communication control means for enabling signal transmission between said shutter controller and said digital still camera apparatus via said first and second communication means when approaching a photographing spot of said digital still camera apparatus, for sending an ID signal to said digital still camera apparatus, and for transmitting a shutter drive signal to said digital still camera apparatus in response to depression of said shutter button; and
said digital still camera apparatus comprises second communication control means for enabling signal transmission between said digital still camera apparatus and said shutter controller via said first and second communication means when said shutter controller approaches said photographing spot, for receiving the ID signal transmitted from said shutter controller, and for receiving the shutter drive signal output from said shutter controller, photographing means for taking a picture by driving a shutter in response to the shutter drive signal received, first storing means for storing the photograph signal from said photographing means in conjunction with the ID signal received, and feeding means for supplying said management apparatus with the photograph signal from said first storing means and the ID signal in conjunction with the photograph signal; and
said management apparatus comprises second storing means for storing the photograph signal supplied from said feeding means and the ID signal in conjunction with the photograph signal, and reading means for reading the photograph signal from said second storing means with reference to the ID associated with the photograph signal.

2. The snapshot system as claimed in claim 1, wherein
said digital still camera apparatus has an exclusive photographing mode;
said second communication means outputs an exclusive photographing instruction signal in the exclusive photographing mode;
said shutter controller comprises priority buttons; and
said first communication control means, receiving the exclusive photographing instruction signal from said digital still camera apparatus, supplies the ID signal to said digital still camera apparatus in response to a specified operation of said priority buttons.

3. The snapshot system as claimed in claim 1, wherein
said digital still camera apparatus has a simultaneous photographing mode;
said second communication means outputs a simultaneous photographing mode signal in said simultaneous photographing mode;
said first communication means, receiving the simultaneous photographing mode signal from said digital still camera apparatus, outputs the shutter drive signal along with the ID signal; and
said second communication means receives, in the simultaneous photographing mode, different ID signals from a plurality of shutter controllers approaching the photographing spot, then said second communication means receives a first shutter drive signal and the ID signal associated with the first shutter drive signal, and when said second communication means receives a second shutter drive signal within a fixed time period after receiving the first shutter drive signal and the ID signal associated with the first shutter drive signal, said first storing means stores the photograph signal based on the first shutter drive signal, the ID signal associated with the first shutter drive signal, and the ID signal associated with the second shutter drive signal.

4. The snapshot system as claimed in one of claims 1-3, wherein said photographing means drives said shutter a plurality of times in response to the ID signal received to photographs a plurality of times.

5. The snapshot system as claimed in any one of claims 1-3, wherein said management apparatus further comprises printing means for printing a picture based on the photograph signal said reading means reads from said second storing means.

6. The snapshot system as claimed in any one of claims 1-3, wherein said management apparatus further comprises feeding means for feeding via the Internet the photograph signal said reading means reads from said second storing means.

7. The snapshot system as claimed claim 4, wherein said management apparatus further comprises printing means for printing a picture based on the photograph signal said reading means reads from said second storing means.

8. The snapshot system as claimed in claim 4, wherein said management apparatus further comprises feeding means for feeding via the Internet the photograph signal said reading means reads from said second storing means.

9. The snapshot system as claimed in claim 6, wherein said management apparatus further comprises means for charging a fee to a client who receives the photograph signal read from said second storing means and transmitted by said feeding means via the Internet.

10. The snapshot system as claimed in claim 8, wherein said management apparatus further comprises means for charging a fee to a client who receives the photograph signal read from said second storing means and transmitted by said feeding means via the Internet.

11. A snapshot system including a portable shutter controller having first communication means, a digital still camera apparatus that has second communication means and is installed at a specified site, and a management apparatus for managing the digital still camera apparatus, said snapshot system carrying out radio transfer of a signal between said shutter controller and said digital still camera apparatus via said first and second communication means, wherein
said shutter controller comprises first communication control means for enabling signal transmission between said shutter controller and said digital still camera apparatus via said first and second communication means when approaching a photographing spot of said digital still camera apparatus, and for sending an ID signal to said digital still camera apparatus; and
said digital still camera apparatus comprises a sensor for detecting that a prescribed condition about the photographing spot is satisfied, second communication control means for enabling signal transmission between said digital still camera apparatus and said shutter controller via said first and second communication means when said shutter controller approaches said photographing spot, and for receiving the ID signal transmitted from said shutter controller, photographing means for taking a picture by driving a shutter in response to the detection signal output from said sensor, first storing means for storing the photograph signal from said photographing means in conjunction with the ID signal received, and feeding means for supplying said management apparatus with the photograph signal from said first storing means and the ID signal in conjunction with the photograph signal; and
said management apparatus comprises second storing means for storing the photograph signal supplied from said feeding means and the ID signal in conjunction with the photograph signal, and reading means for reading the photograph signal from said second storing means with reference to the ID associated with the photograph signal.

12. The snapshot system as claimed in claim 11, wherein said photographing means drives said shutter a plurality of times in response to the ID signal received to photographs a plurality of times.

13. The snapshot system as claimed in claim 11 or 12, wherein said management apparatus further comprises printing means for printing a picture based on the photograph signal said reading means reads from said second storing means.

14. The snapshot system as claimed in claim 11 or 12, wherein said management apparatus further comprises feeding means for feeding via the Internet the photograph signal said reading means reads from said second storing means.

15. The snapshot system as claimed in claim 14, wherein said management apparatus further comprises means for charging a fee to a client who receives the photograph signal read from said second storing means and transmitted by said feeding means via the Internet.
